(19) United States
(12) Patent Application Publication
(10) Pub. No.: US 2013/0151553 A1
(43) Pub. Date: Jun. 13, 2013

(54) METHOD AND APPARATUS FOR PROCESSING A COMPOSITE CONTEXT EVENT

(71) Applicant: Eung-Ha KIM, Daejeon-si (KR)

(72) Inventor: Eung-Ha KIM, Daejeon-si (KR)

(73) Assignee: Electronics and Telecommunications Research Institute, Daejeon (KR)

(21) Appl. No.: 13/618,260

(22) Filed: Sep. 14, 2012

(30) Foreign Application Priority Data
Dec. 13, 2011 (KR) 10-2011-0133932

(51) Int. Cl. G06F 17/30

(52) U.S. Cl. 707/769; 707/758; 707/E17.014

(57) ABSTRACT

There is provided a system for processing composite context events that provides a composite context-aware application service developer with an interface enabling subscription to composite context information such that the service developer can easily use the composite context information in a composite context-aware application service, and receives, when an event corresponding to the subscribed composite context information is generated, a result of processing the composite context information so as to provide a user with an appropriate context-aware service according to a result of processing the composite context information.

### CROSS-REFERENCE TO RELATED APPLICATION

This application claims the benefit under 35 U.S.C. §119(a) of Korean Patent Application No. 10-2011-0133932, filed on Dec. 13, 2011, the entire disclosure of which is incorporated herein by reference for all purposes.

### BACKGROUND

1. Field

The following description relates to a method and apparatus for processing events related to composite context information.

2. Description of the Related Art

With development of digital convergence and popularization of smart phones, requirements for user-oriented services are increasing. In order to implement user-oriented services, context-aware technology is very important. A context-aware service of recognizing composite context information can be more realistically and efficiently applied to a real-world service environment than a service of recognizing unit context information. Specifically, a user-oriented context-aware service needs to allow a user to designate specific situations so that the user can receive an appropriate service when one of the designated situations occurs.

Most initial studies into composite context-aware services were aimed at configuring a prototype application only for a specific platform by combining various kinds of context information with a context sensing technology. However, since such a conventional context-aware system is associated only with a specific platform, much advance knowledge is required for extension. Furthermore, since modularization of common functions was never considered, there are difficulties in re-using the system.

In order to overcome these problems, studies into a context-aware service infrastructure have been actively conducted. As one of such studies, a method of separating common functions needed for development of composite context-aware application services from an application level and providing developers with the functions in the form of a service infrastructure has been proposed. A composite context processing service infrastructure allows developers to concentrate on functions associated with application services, and provides users with generalized application services. However, in spite of many studies into context-aware services, there are still difficulties in applying composite context processing to application services. Accordingly, it is necessary to establish an environment for processing composite context events.

One of conventional context-aware technologies is disclosed in Korean Patent Application No. 10-2007-0132322, entitled “Context information Aware System and Context Information Aware Method in Context Information Aware System”, filed on Dec. 17, 2007.

### SUMMARY

The following description relates to a system for processing composite context events that provides a composite context-aware application service developer with an interface enabling subscription to composite context information such that the service developer can easily use the composite context information in a composite context-aware application service, and receives, when an event corresponding to the subscribed composite context information is generated, a result of processing the composite context information so as to provide a user with an appropriate context-aware service.

In one general aspect, there is provided an apparatus of processing a composite context event, including: a subscription processing unit configured to process subscription of composite context information according to a composite context information subscription request; a unit context information processing unit configured to collect unit context information, and to determine whether data of the collected unit context information is different from previously collected data of the corresponding unit context information; and a composite context processing unit configured to determine, if the data of the collected unit context information is different from the previously collected data of the unit context information, whether subscription to composite context information including the collected unit context information has been processed by the subscription processing unit, and to determine, if the composite context information including the collected unit context information has been subscribed to, whether a composite situation corresponding to the composite context information has actually occurred.

In another general aspect, there is provided a method of processing a composite context event, including: processing subscription of composite context information according to a composite context information subscription request, the composite context information consisting of at least one piece of unit context information; collecting unit context information, and determining whether data of the collected unit context information is different from previously collected data of the corresponding unit context information; determining, if the collected unit context information is different from the previously collected data of the corresponding unit context information, whether composite context information including the collected unit context information has been subscribed to; and determining, if the composite context information including the collected unit context information has been subscribed to, whether a composite situation corresponding to the composite context information has actually occurred.

Other features and aspects will be apparent from the following detailed description, the drawings, and the claims.

### BRIEF DESCRIPTION OF THE DRAWINGS

FIG. 1 is a diagram illustrating an example of a composite context processing system.

FIG. 2 is a diagram illustrating an example of a composite context event processing apparatus.

FIG. 3 shows a configuration of an example of a subscription information storage unit that is used to process composite context events.

FIG. 4 shows a configuration of an example of a rule storage unit that stores configuration information for composite context.

FIG. 5 shows a configuration of an example of a unit context information storage unit.

FIG. 6 is a flowchart illustrating an example of a method of processing composite context events.

FIGS. 7 through 11 are flowcharts illustrating in detail examples of operations of processing composite context events.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

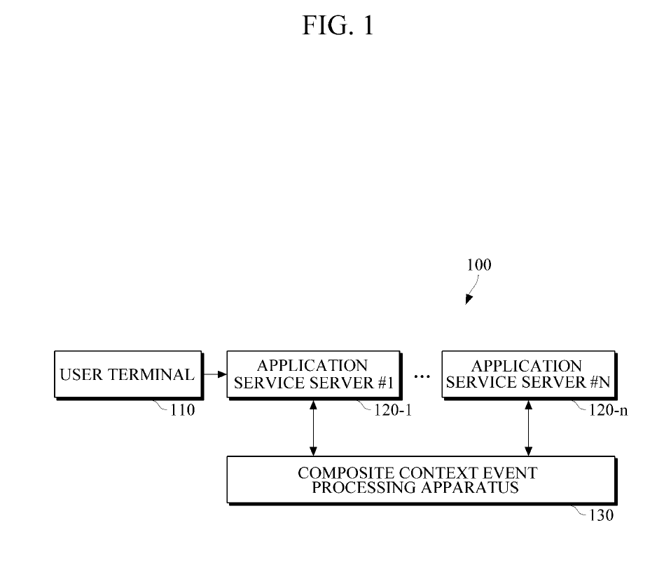

FIG. 1 is a diagram illustrating an example of a composite context processing system 100.

The composite context processing system 100 includes a user terminal 100, a plurality of application service servers 120-1 through 120-n, and a composite context event processing apparatus 130.

The term “composite context information” means a combination of a plurality of pieces of unit context information. Composite context information is created by combining a plurality of pieces of unit context information using logical operators. Unit context information represents context data about the corresponding unit situation. Unit context information may be a specific time, such as 10:00 AM, 05:00 PM, a change in peripheral environment such as turning on/off the light in a specific room, or the generation of a specific behavior, such as receiving E-mail from a specific person, transmitting E-mail to a specific person, a specific person's visit, etc. The logical operators may be operators, such as AND, OR, NOR, NOT, etc. By combining two or more pieces of unit context information using logical operators it is possible to create various kinds of context information.

The user terminal 110 may be one of various kinds of terminals, such as a smart phone, a notebook, a personal computer, a mobile phone, etc. Applications that use composite context information may be executed in the user terminal 110. FIG. 1 shows a single user terminal 110, however, there may be a plurality of user terminals that use the plurality of application service servers 120-1 through 120-n.

The plurality of application service servers 120-1 through 120-n provide application services that use composite context information. Each of the application service servers 120-1 through 120-n may be configured to provide an application service to the user terminal 110 through the corresponding application installed in the user terminal 110.

The composite context event processing apparatus 130 provides a composite context information subscription interface enabling subscription to composite context information so that composite context-aware service developers can use the composite context information to develop composite context-aware services. Also, the composite context event processing apparatus 130 creates subscription information which represents composite context information awaiting subscription, and stores the subscription information in a predetermined storage area. If a composite context event occurs, the composite context event processing apparatus 130 recognizes the composite context event to search for composite context information corresponding to the composite context event in the stored subscription information, and provides the result of processing the found composite context information to an application service server (for example, the application service server #1 120-1) requesting subscription to the corresponding composite context information, through a notification interface.

For this, the composite context event processing apparatus 130 may recognize individual unit situations configuring a composite situation corresponding to the composite context information, and determine whether the composite situation has actually occurred, based on the recognized unit situations. For example, the composite context event processing apparatus 130 may be configured to collect unit context information indicating a unit situation in real time.

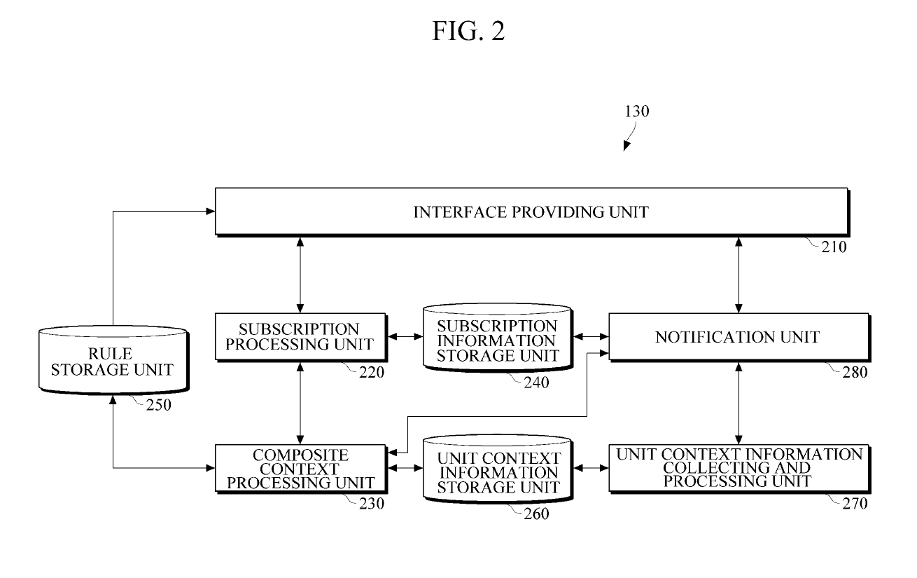

FIG. 2 is a diagram illustrating an example of the composite context event processing apparatus 130 illustrated in FIG. 1.

Referring to FIG. 2, the composite context event processing apparatus 130 may include an interface providing unit 210, a subscription processing unit 220, a composite context processing unit 230, a subscription information storage unit 240, a rule storage unit 250, a unit context information storage unit 260, a unit context information collecting and processing unit 270, and a notification unit 280.

The interface providing unit 210 provides an interface for data transmission/reception through communication with the plurality of application service servers 120-1 through 120-n (see FIG. 1). The interface providing unit 210 provides the application service servers 120-1 through 120-n that use composite context information with an interface enabling subscription to composite context information.

At least one of the application service servers 120-1 through 120-n transmits a composite context information subscription request to the composite context event processing apparatus 130 through the interface provided by the interface providing unit 210.

For convenience of description, it is assumed that the application service server 120-1 transmits a composite context information subscription request to the composite context event processing apparatus 130 through the interface providing unit 210. The composite context information subscription request may include a user identifier and a composite context information name. The composite context information name is information specifying the composite context information.

Then, the interface providing unit 210 determines whether the composite context information to which subscription has been requested has been defined. The interface providing unit 210 may determine whether the composite context information has been defined by searching for the composite context information in the rule storage unit 250. For example, the interface providing unit 210 may determine whether the composite context information has been stored in the rule storage unit 250 using the composite context information name included in the composite context information subscription request.

The rule storage unit 250 stores configuration information about predefined composite context information. The rule storage unit 250 may store the configuration information about the predefined composite context information in the form of a list. In more detail, the rule storage unit 250 may store a composite context information configuration list (hereinafter, simply referred to as a configuration list) in which each piece of composite context information is mapped to a plurality of pieces of unit context information configuring the composite context information, and a composite context information logical operator list (hereinafter, simply referred to as a logical operator list) including operators that define the logical relationship between a plurality of pieces of unit context information configuring each piece of composite context information. The configuration list and the logical operator list are predefined rule information for composite context information.

If the composite context information to which subscription has been requested has been defined, the interface providing unit 210 requests that the subscription processing unit 220 process subscription to the composite context information.

Then, the subscription processing unit 220 requests that the composite context processing unit 230 send a configuration list including a plurality of pieces of unit context information configuring the composite context information.

The composite context processing unit 230 receives the request from the subscription processing unit 220, extracts the requested configuration list from the rule storage unit 250, and transfers the extracted configuration list to the subscription processing unit 220.

The subscription processing unit 220 creates subscription information including the received configuration list, the composite context information name, the user identifier, and the address of the application service server 120-1 requesting subscription to the composite context information, and stores the subscription information in the subscription information storage unit 240. The address of the application service server 120-1 requesting subscription to the composite context information may be referred to as an application service address. The application service address may be received directly from the application service server 120-1 through communication between the interface providing unit 210 and the application service s server 120-1, or may be included in the composite context information subscription request and received by the interface providing unit 210.

Then, the subscription processing unit 220 transfers a subscription completion message to the interface providing unit 210. The interface providing unit 210 receives the subscription completion message and transmits the subscription completion message to the application service server 120-1.

The unit context information processing unit 270 may collect unit context information from a plurality of situation sources. The plurality of situation sources may be devices, user terminals, networks, services provided on a network, etc. According to the kind of a situation source, the unit context information may be device context information, user context information, is network context information, service context information, etc. However, the unit context information is not limited to the above-mentioned information.

Device context information is information representing a plurality of situations about the device. For example, device context information may include a device name, GPS information representing the location of the corresponding device, and the type of a network to which the device has connected, etc.

User context information is information representing a plurality of situations about the user. For example, user context information may include a user name, the user's phone number, the user's preferences information, the user's age, the user's gender, a communication service to which the user has subscribed, etc.

Network context information is information representing a plurality of situations about the network. For example, network context information may include a network type, a network provider, etc.

Service context information is information representing a plurality of situations about the service provided on a network. Here, the service may be a service that is provided by the application service servers 120-1 through 120-n, or a service that can be provided by interworking with the application service servers 120-1 through 120-n. For example, service context information may include a service name, service state information, etc.

When unit context information is input to the unit context information processing unit 270, it can be considered that a unit context event occurs. The unit context information processing unit 270 may process a unit situation whenever it receives unit context information. The unit context information may be data (for example, a value or content representing a specific situation) representing the corresponding unit situation according to the kind of the unit context information. Data representing a certain situation of a specific situation source may be received in various ways according to the kind of each unit situation. For example, location information of device context information may be periodically received from the corresponding device.

The unit context information processing unit 270 receives unit context information generating a unit context event, and accesses the unit context information storage unit 260 to extract data of the corresponding unit context information from the unit context information storage unit 260, in order to recognize current data regarding the unit context information generating the unit context event. Then, the unit context information processing unit 270 compares the extracted unit context information data to the unit context information generating the unit context event, and if the extracted unit context information data is different from the unit context information generating the unit context event, changes the unit context information data stored in the unit context information storage unit 260 to the unit context information generating the unit context event. Then, the unit context information processing unit 270 transfers the unit context information generating the unit context event to the notification unit 280.

The notification unit 280 receives the unit context information from the unit context information processing unit 270, and searches for the unit context information in the configuration list stored in the subscription information storage unit 240. If the same unit context information is found in the configuration list, the notification unit 280 searches for composite context information including the unit context information in the configuration list. Also, the notification unit 280 searches for the address of the application service server (for example, the application service server 120-1) that subscribed to the found composite context information.

Then, the notification unit 280 requests that the composite context processing unit 230 process the found composite context information. Processing composite context information means determining whether the corresponding composite situation has actually occurred. A composite context processing request may be generated as a composite context processing start event.

As described above, composite context information is composed of two or more pieces of unit context information and one or more logical operators (AND, OR, NOT, etc.). Accordingly, the composite context processing start event corresponds to the case where an event occurs in two or more pieces of unit context information configuring the composite context information, and may be defined as the case where one or more pieces of the unit context information generating the event are different from the corresponding unit context information data before the event was generated. Accordingly, a composite context processing start event is sensed through an event related to each piece of the unit context information configuring the composite context information.

Also, if the unit context information whose data has changed is service context information, the notification unit 280 may search for all subscription information including at least one piece of unit context information related to the service context information, and request the composite context processing unit 230 to process composite context information corresponding to all the found subscription information. Also, if the unit context information whose data has changed is network context information, the notification unit 280 may search for all subscription information including at least one piece of unit context information related to the network context information, and request the composite context processing unit 230 to process composite context information corresponding to all the found subscription information.

When a composite context processing start event occurs, in order to determine whether the corresponding composite situation has actually occurred, the composite context processing unit 230 searches for configuration information or a rule (that is, a configuration list and a logical operator(s)) of the composite context information requested to be processed in the rule storage unit 250, and searches for unit context information configuring the composite context information in the unit context information storage unit 260. Thereby, the composite context processing unit 230 may determine whether the corresponding composite situation has actually occurred, and check detailed information about the composite context information.

The composite context processing unit 230 may process the composite context information using pre-established ontology information (not shown). The ontology information may be stored in a separate storage unit included in the composite context processing apparatus 130, or the composite context processing apparatus 130 may search for the ontology information through a network. The ontology information may be created in various manners, and the ontology information may include static context information and dynamic context information, wherein the static context information is information which is little changed, and the dynamic context information may be generated by user information received from the outside when the user accesses the system, or by external environment information, and also the dynamic context information may be real-time status information generated by various environments associated with the user. The ontology information may include user-related information (the type of the user's terminal, the user's physical location, etc.), network-related information (a bandwidth, a delay time, a security level, etc.), service-related information (the physical location of the corresponding service application server, a processing time, a service charge, etc.), etc. Also, the ontology information may include information that can be newly created based on the above-mentioned information.

By checking that if a plurality of pieces of composite context information including the unit situation corresponding to the changed unit context information data are found in the subscription information storage unit 240, the composite context processing unit 230 may determine whether composite situations corresponding to the plurality of pieces of composite context information have actually occurred, respectively.

The composite context processing unit 230 may transfer the results of processing the composite context information to the notification unit 280. The notification unit 280 receives the results of processing, and transfers the results of processing and the address of the application service server 120-1 that subscribed to the composite context information to the interface providing unit 210. If the unit context information generating the unit context event is service context information or network context information, the results of processing may influence a plurality of user terminals that receive an application service through the application service server 120-1.

The interface providing unit 210 may transfer the results of processing the subscribed--n composite context information to the application service server 120-1 having the received address of the application service server 120-1. The results of processing the subscribed composite context information may include information indicating whether or not the corresponding composite situation has actually occurred, and various data related to the generated composite situation.

As such, establishment of an environment for processing composite context events may contribute to creation of a new communication service field based on user-oriented composite context-aware service technology.

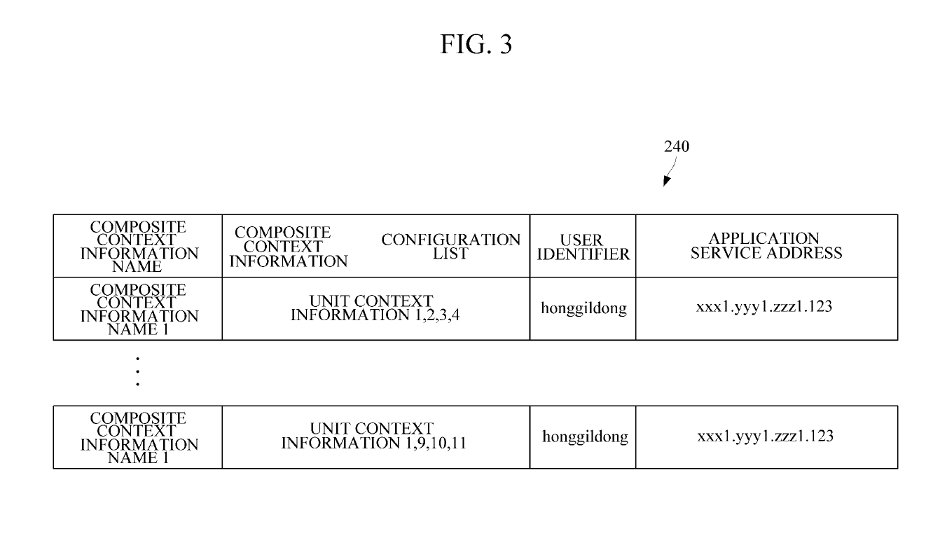

FIG. 3 shows a configuration of an example of the subscription information storage unit 240 of FIG. 2, which is used to process composite context events.

The subscription information storage unit 240 stores a plurality of pieces of subscription information including composite context information names, composite context information configuration lists extracted from the rule storage 250, user identifiers, and composite context-aware application service addresses. The subscription information storage unit 240 may store the plurality of pieces of subscription information in the form of a list.

The composite context information names are composite context information names included in composite context information subscription requests received from the application service servers 120-1 through 120-n.

Each composite context information configuration list is a list of unit context information configuring the subscribed composite context information.

Each application service address is the address of an application service server requesting subscription to the corresponding composite context information. The application service address is used to notify, when a composite context processing start event occurs, the results of processing the composite context information to the application service server requesting subscription to the composite context information.

When a device context event or a user context event occurs in relation with a particular user, user identifier is used to issue notification regarding only composite context information subscribed to with respect to the particular user.

As shown in the example of FIG. 3, a composite context information configuration list for “composite context information name 1” is “unit context information 1, 2, 3, and 4”, the identifier of a user requesting subscription to the composite context information corresponding to “composite context information name 1” is “honggildong”, and the address of an application service server requesting subscription to the corresponding composite context information is “xxx1.yyy1.zzz1.123”.

When a network context event or a service context event occurs, this event relates not only to one particular user but to a plurality of users, and thus the composite context processing apparatus 130 may issue notification regarding all composite context information subscribed to with respect to composite context information event.

For this, if composite context information to which subscription has been requested is related to a plurality of users that use a specific device, not related to a specific user, the corresponding composite context information subscription request may include a device identifier. Accordingly, the corresponding subscription information also may include the device identifier, instead of a user identifier or together with the user identifier.

Meanwhile, if composite context information to which subscription has been requested is related to a plurality of users that use a specific service or network or to a plurality of networks, the corresponding composite context information subscription request may include a service identifier and/or a network identifier(s). Accordingly, the corresponding subscription information also may include the service identifier and/or the network identifier(s), instead of a user identifier or together with the user identifier.

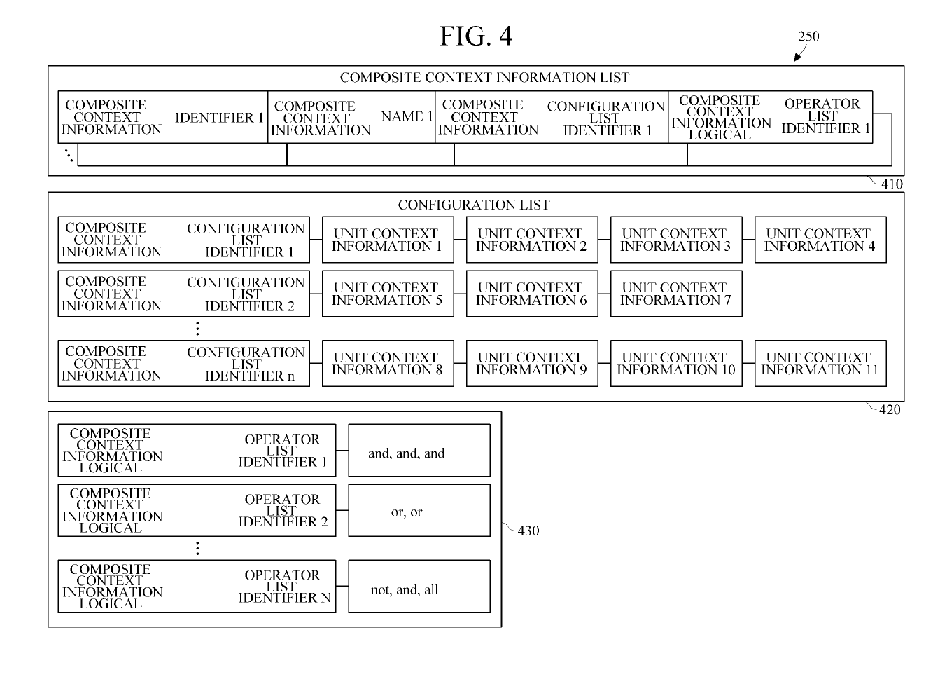

FIG. 4 shows a configuration of an example of the rule storage unit 250 that stores configuration information for composite context information.

The rule storage unit 250 may include a composite context information list 410, a composite context information configuration list 420, and a composite context information operator list 430.

The composite context information list 410 may include composite context information identifiers, composite context information names, composite context information configuration list identifiers that indicate locations at which lists of unit context information configuring the corresponding composite context information are stored, and composite context information logical operator list identifiers that indicate locations at which logical operators for the corresponding composite context information are stored.

The composite context information configuration list identifiers of the composite context information list 410 are associated with the composite context information configuration list 420.

The composite context information configuration list 420 stores unit context information configuring each piece of composite context information. The composite context information configuration list 420 may include composite context information configuration list identifiers and a plurality of pieces of unit context information configuring each piece of composite context information.

The composite context information logic operator list identifiers of the composite context information list 410 are associated with the composite context information operator list 430. The composite context information operator list 430 may include composite context information logical operator list identifiers and logical operators for each piece of composite context information.

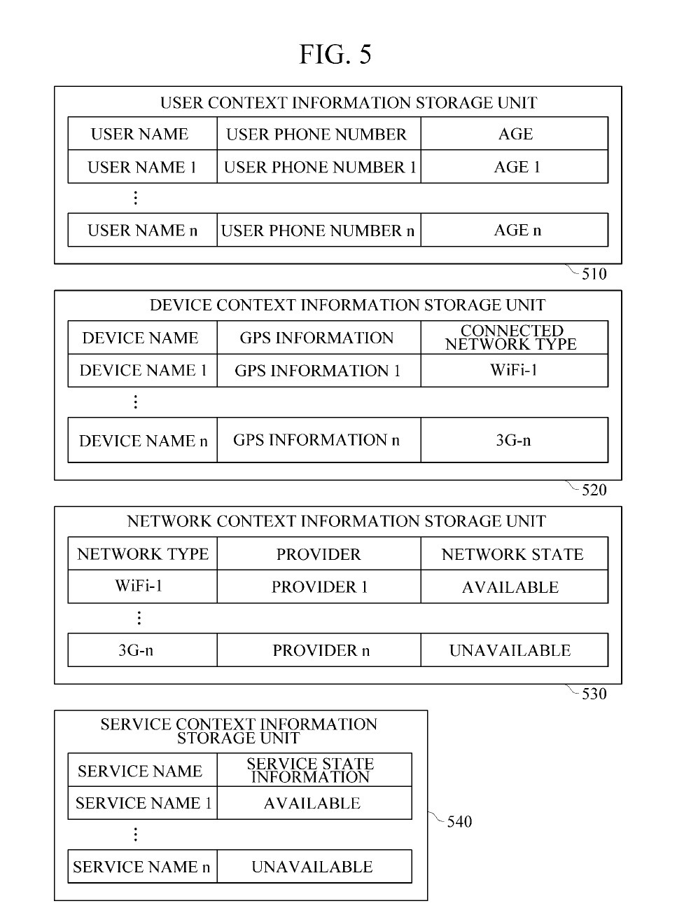

FIG. 5 shows a configuration of an example of the unit context information storage unit 260 of FIG. 2.

The unit context information storage unit 260 may include a user context information storage 510, a device context information storage 520, a network context information storage 520, and a service context information storage 540, according to the kind of unit context information.

The user context information storage 510 may store unit context information for each user. The unit context information for each user may include the user's age, name, phone number, etc. However, the unit context information for each user is not limited to the above-mentioned context information, and may include arbitrary information about the user's situations or states. For example, unit context information for a user 1 may include “name 1”, “phone number 1”, and “age 1”.

The device context information storage 520 may store unit context information for each device. Unit context information for each device may include an identifier of the device, a model number of the device, GPS data of the device, and information about the type of a network to which the device is connected. However, the unit context information for each device is not limited to the above-mentioned information. For example, unit context information for a device 1 may include “identifier 1”, “GPS information 1”, and “WiFi-1”.

The network context information storage 530 may store network identifiers, network types, network providers, and network states. However, the network context information storage 530 may further store unit context information that represents various kinds of network states, other than the above-mentioned information. For example, unit context information for a network 1 may include “WiFi-1”, “network type 1”, and “provider 1”.

The service context information storage 540 may store service names, service state information, etc. However, the service context information storage 540 may further store unit context information that represents various kinds of service states, other than the above-mentioned information. For example, unit context information of a service 1 may include “service name 1” and “available”.

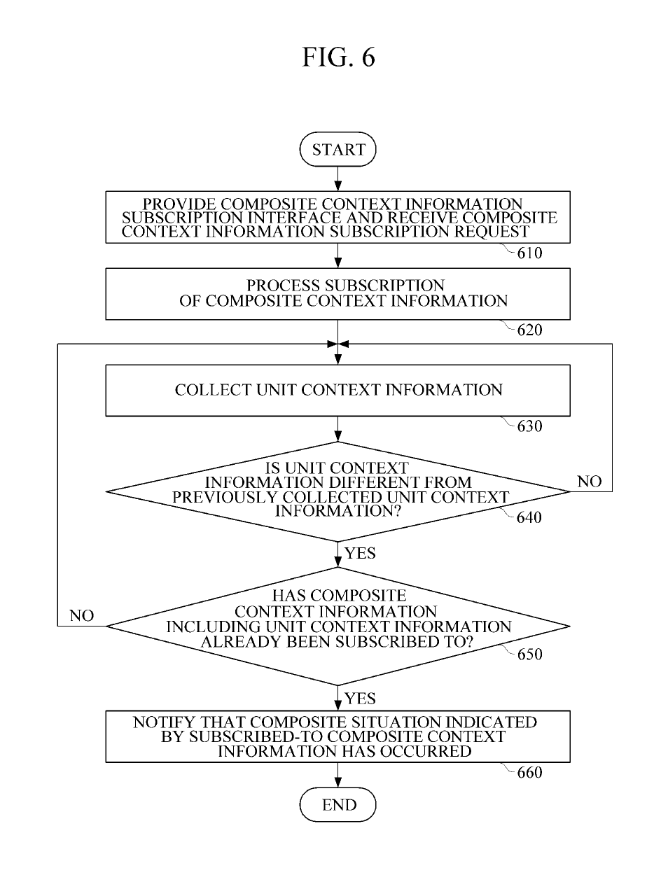

FIG. 6 is a flowchart illustrating an example of a method of processing composite context events.

The composite context event processing apparatus 130 (see FIG. 1) receives a composite context information subscription request from an application server that uses composite context information composed of at least one piece of unit context information, and provides a composite context information subscription interface in response to the composite context information subscription request (610).

Then, the composite context event processing apparatus 130 processes the corresponding composite context information to be subscribed to, according to the composite context information subscription request (620).

The composite context event processing apparatus 130 collects unit context information data for the composite context information (630). The operations 610 and 620 do not need to be performed before the operation 630. The composite context event processing apparatus 130 may process the operations 610 and 620, separately from the operation 630, if it receives a plurality of pieces of composite context information subscription requests from a plurality of application service servers simultaneously or at different times.

The composite context event processing apparatus 130 may determine whether data of the collected unit context information is different from previously collected data of the corresponding unit context information (640). If the collected unit context information data is identical to the previously collected unit context information data, the composite context event processing apparatus 130 may continue to perform the operation 630.

If the collected unit context information data is different from the previously collected unit context information data, the composite context event processing apparatus 130 determines whether composite context information including the unit context information corresponding to the collected unit context information data has already been subscribed to (650). If the composite context information has never been subscribed to, the composite context event processing apparatus 130 may continue to perform the operation 630.

If the composite context information has already been subscribed to, the composite context event processing apparatus 130 notifies an application service server requesting subscription to the composite information that a composite situation indicated by the subscribed-composite context information has actually occurred (660).

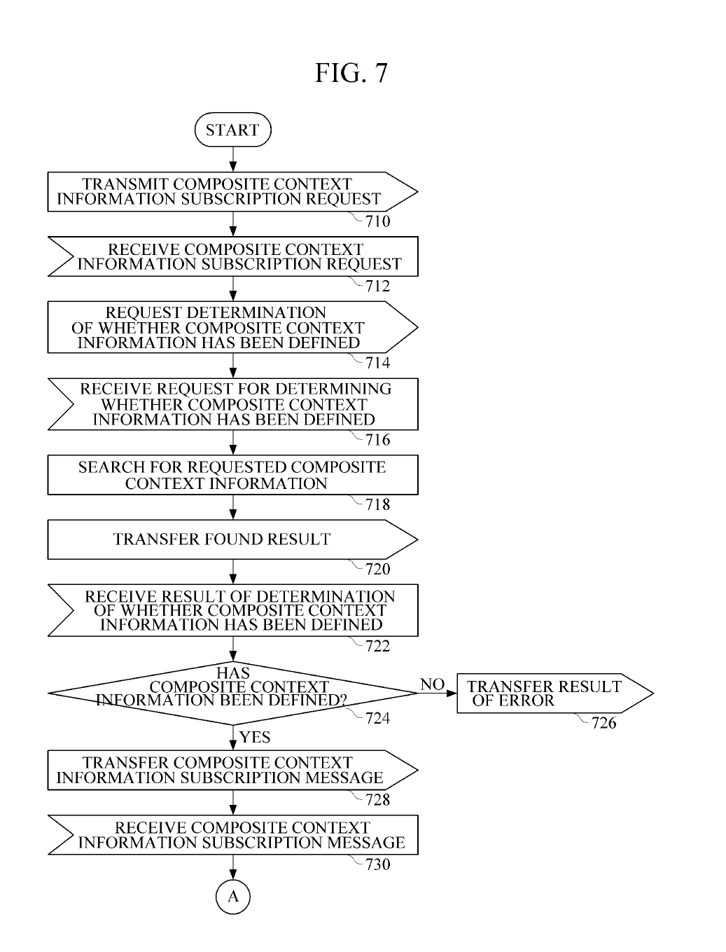

FIGS. 7 through 11 are flowcharts illustrating in detail examples of operations of processing composite context events.

Referring to FIGS. 1, 2, and 7, one of the application service servers 120-1 through 120-n transmits a composite context information subscription request to the composite context event processing apparatus 130, using a composite context information subscription interface.

The interface providing unit 210 of the composite context event processing apparatus 130 receives the composite context information subscription request (712). At this time, the interface providing unit 210 receives a user identifier and composite context information included in the received composite context information subscription request. Here, the composite context information may be information indicating a specific composite situation, for example, a composite context information name. For example, the composite context information name may be a term indicating a specific situation such as “in conference”.

The interface providing unit 210 requests that the composite context processing unit 230 determine whether the composite context information to which subscription has been requested has been defined, in order to determine whether the received composite context information exists in a predefined composite context information list (714).

The composite context processing unit 230 receives the request from the interface providing unit 210 (716), and searches for the corresponding composite context information in the rule storage unit 250 (718). The composite context processing unit 230 transfers the found result to the interface providing unit 210 (720).

The interface providing unit 210 receives the result of the determination of whether the composite context information has been defined (722). If the received result indicates that the composite context information has been not defined (724), the interface providing unit 210 notifies the application service server requesting subscription to the composite context information that the corresponding request cannot be processed (726).

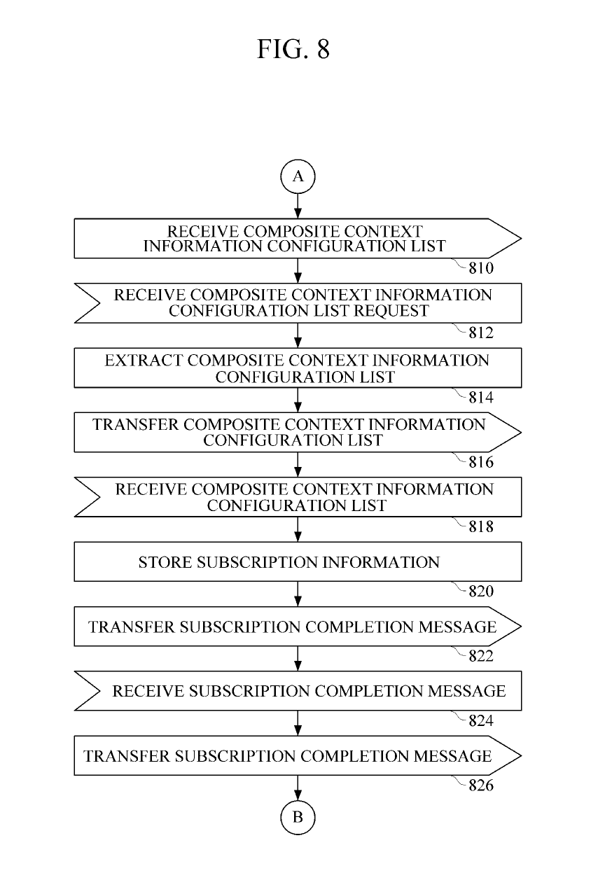

If the received result indicates that the composite context information has been defined (724), the interface providing unit 210 transfers a composite context information subscription request message including the composite context information, a user identifier, and the address of the application service server requesting subscription to the composite context information, to the subscription processing unit 220 (728). The subscription processing unit 220 receives the subscription request message (730). The following operations will be described below with reference to FIG. 8.

The composite context processing unit 230 receives the composite context information and the corresponding composite context information configuration list (810). The composite context information configuration list includes unit context information configuring the composite context information.

Referring to FIGS. 1, 2, and 8, the composite context processing unit 230 receives the request for requesting the composite context information configuration list (812), extracts the composite context information configuration list from the rule storage unit 250 (814), and transfers the extracted composite context information configuration list to the subscription processing unit 220 (816).

The subscription processing unit 220 receives the composite context information configuration list (818), and stores the composite context information configuration list and subscription information about the composite context information, the subscription information including the composite context information, the user identifier, and the address of the application service server, in the subscription information storage unit 240 (820).

Then, the subscription processing unit 220 transfers a subscription completion message to the interface providing unit 210 (822). The interface providing unit 210 receives the subscription completion message (824), and transfers the subscription completion message to the application service server requesting subscription to the composite context information (826).

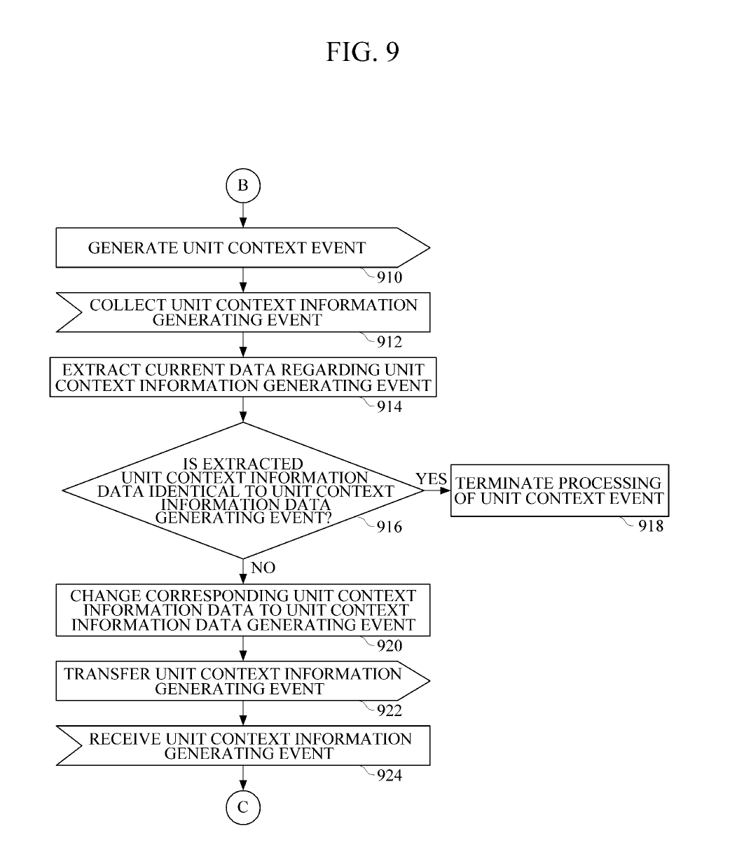

The following operations will be described below with reference to FIG. 9.

Referring to FIGS. 1, 2, and 9, if a unit context event occurs from a situation source composed of a device, a user, a network, service context information, etc. (910), the unit context information processing unit 270 collects unit context information generating the unit context event (912). The unit context information processing unit 270 extracts data of the corresponding unit context information from the unit context information storage 260, in order to recognize current data (or a value representing a current unit context information) regarding the unit context information generating the unit context event (914).

The unit context information processing unit 270 compares the extracted unit context information data with data of the unit context information generating the unit context event (916), and terminates processing of the unit context event if the extracted unit context information data is identical to the unit context information data generating the unit context event, since it is considered that there is no change in unit context information (918).

Meanwhile, if the extracted unit context information data is different from the unit context information data generating the unit context event, the unit context information processing unit 270 changes the corresponding unit context information data to the unit context information data generating the unit context event and stores the changed unit context information data in the unit context information storage 260 (920).

Then, the unit context information processing unit 270 transfers the unit context information generating the unit context event to the notification unit 280 (922). The notification unit 280 receives the unit context information generating the unit context event (924).

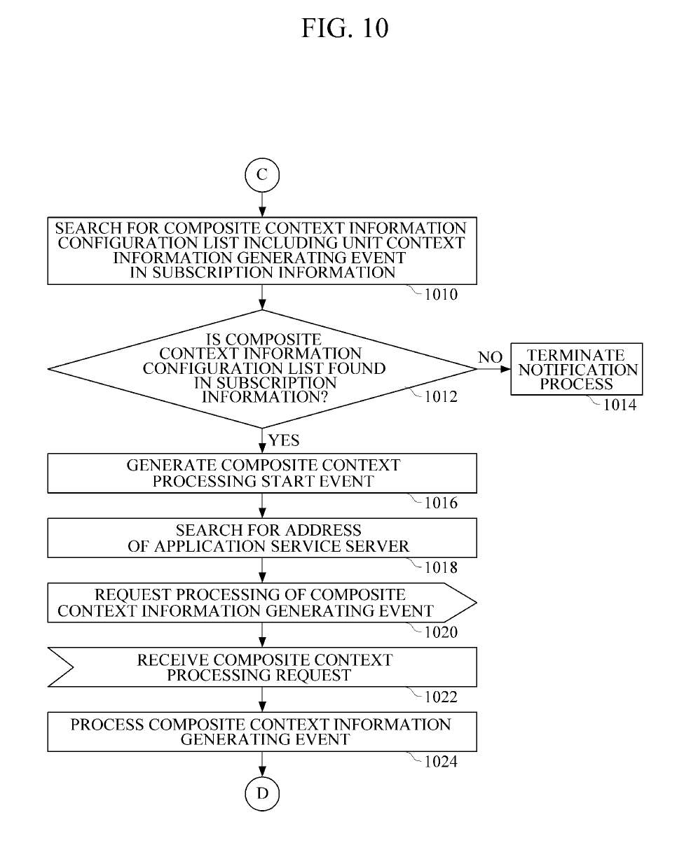

The following operations will be described below with reference to FIG. 10.

Referring to FIGS. 1, 2, and 10, the notification unit 280 receives the unit context information generating the unit context event, and determines whether the unit context information generating the unit context event is found in unit context information configuring each composite information list in subscription information stored in the subscription information storage 240 (1010).

If the unit context information generating the unit context information is not found in the unit context information included in the subscription information (1012), the notification unit 280 terminates the notification process (1014).

Meanwhile, if the unit context information generating the event is found in the unit context information included in the subscription information (1012), the notification unit 280 generates a composite context processing start event (1016).

Then, the notification unit 280 searches for the address of an application service server requesting subscription to the found composite context information, in the subscription information storage 240 (1018).

Next, the notification unit 280 requests that the composite context processing unit 230 process the composite context information generating the composite context processing start event (1020).

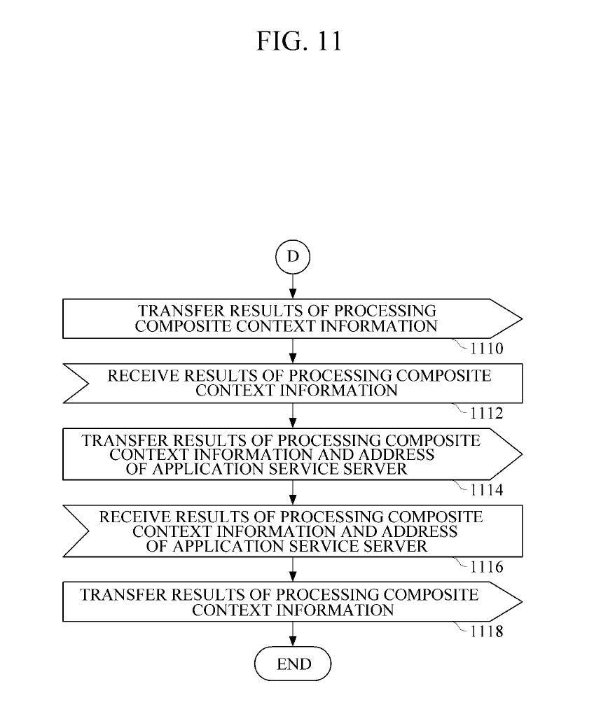

The composite context processing unit 230 receives the request for processing the composite context information (1022), searches for a rule of the corresponding composite context information in the rule storage unit 250, and processes the composite context information according to the found rule using unit context information database (1024). The following operations will be described below with reference to FIG. 11.

Referring to FIGS. 1, 2, and 11, after the composite context information is processed, the composite context processing unit 230 transfers the result of processing the composite context information to the notification unit 280 (1110).

The notification unit 280 receives the results of processing the composite context information (1112), and transfers the results of processing and the address of the application service server requesting subscription to the composite context information to the interface providing unit 210 (1114).

The interface providing unit 210 receives the results of processing and the address of the application service server (1112), and notifies the application service server that the subscribed composite context event occurs to thereby transfer the result of processing the composite context information to the application service server (1118). In this way, a system for processing composite context events processes composite context events.

Therefore, according to the method of processing composite context events described above, the following effects can be obtained.

First, by providing composite context-aware application service developers with an opportunity for easily developing various context-aware services and sharing them it is possible to establish an open service development environment capable of significantly reducing limitation in developing context-aware services.

Second, it is possible to provide a technical mechanism enabling the creation of new communication services, such as a next-generation internet service control infrastructure and user-oriented context-aware services.

Third, by allowing re-use of composite context information components that have been already established or are to be created in the future in developing various context-aware services that can be used as new business models, is it possible to reduce the cost of developing context-aware services.

The present invention can be implemented as computer-readable code in a computer-readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier waves such as used in Internet transmission. In addition, the computer-readable recording medium may be distributed to computer systems over a network, in which computer-readable code may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus of processing a composite context event, comprising:
a subscription processing unit configured to process subscription of composite context information according to a composite context information subscription request;
a unit context information processing unit configured to collect unit context information, and to determine whether data of the collected unit context information is different from previously collected data of the corresponding unit context information; and
a composite context processing unit configured to determine, if the data of the collected unit context information is different from the previously collected data of the unit context information, whether subscription to composite context information including the collected unit context information has been processed by the subscription processing unit, and to determine, if the composite context information including the collected unit context information has been subscribed to, whether a composite situation corresponding to the composite context information has actually occurred.

2. The apparatus of claim 1, wherein the composite context information subscription request includes at least one of a user identifier, a device identifier, a network identifier, and a service identifier, and a composite context information name.

3. The apparatus of claim 2, further comprising:
an interface providing unit configured to provide an application service server that uses composite context information with a composite context information subscription interface, and to receive a composite context information subscription request from the application service server;
a rule storage unit configured to store a composite context information configuration list including a plurality of pieces of unit context information configuring each piece of composite context information, and a composite context information rule representing a logical relationship between the plurality of pieces of unit context information;
a subscription information storage unit configured to store at least one piece of subscription information created according to the composite context information subscription request; and
a notification unit configured to notify an application service server requesting subscription to composite context information that a composite situation corresponding to the composite context information has actually occurred.

4. The apparatus of claim 3, wherein the interface providing unit determines whether composite context information indicated by a composite context information name included in the composite context information subscription request has been defined, if the composite context information has been defined searches for a composite context information configuration list corresponding to the composite context information in the composite context information rule storage unit, and transfers the found composite context information configuration list to the subscription processing unit, and
the subscription processing unit creates subscription information using the composite context information configuration list, and stores the subscription information in the subscription information storage unit.

5. The apparatus of claim 4, wherein the subscription information includes the composite context information name, a composite context information identifier, the composite context information configuration list including a plurality of pieces of unit context information configuring the corresponding composite context information, an address of an application service server requesting subscription to the composite context information, and at least one of a user identifier, a device identifier, a network identifier, and a service identifier.

6. The apparatus of claim 3, wherein if the data of the collected unit context information is different from the previously collected data of the corresponding unit context information and subscription to the composite context information including the unit context information has been processed by the subscription processing unit, the notification unit searches for an address of an application service server requesting subscription to the composite context information in the subscription information storage unit, and transfers the found address of the application service server to the interface providing unit when the notification unit notifies the application server requesting subscription to the composite context information that a composite situation corresponding to the composite context information has actually occurred.

7. The apparatus of claim 3, wherein if the data of the collected unit context information is different from the previously collected data of the corresponding unit context information, the composite context processing unit searches for subscription information including the unit context information in the subscription information storage unit in order to determine whether subscription to the composite context information including the unit context information has been processed by the subscription processing unit.

8. The apparatus of claim 7, wherein if a plurality of pieces of subscribed composite context information including the unit context information are found in the subscription information storage unit, the composite context processing unit determines whether a composite situation corresponding to each of the plurality of pieces of composite context information has actually occurred.

9. The apparatus of claim 7, wherein the unit context information includes service context information representing a state of a service provided on a network, and
the notification unit searches for all subscription information including at least one piece of unit context information related to the service context information, and requests the composite context processing unit to process composite context information corresponding to all the found subscription information.

10. The apparatus of claim 7, wherein the unit context information includes network context information, and
the notification unit searches for all subscription information including at least one piece of unit context information related to the network context information, and requests the composite context processing unit to process composite context information corresponding to all the found subscription information.

11. A method of processing a composite context event, comprising:
processing subscription of composite context information according to a composite context information subscription request, the composite context information consisting of at least one piece of unit context information;
collecting unit context information, and determining whether data of the collected unit context information is different from previously collected data of the corresponding unit context information;
determining, if the collected unit context information is different from the previously collected data of the corresponding unit context information, whether composite context information including the collected unit context information has been subscribed to; and
determining, if the composite context information including the collected unit context information has been subscribed to, whether a composite situation corresponding to the composite context information has actually occurred.

12. The method of claim 11, wherein the composite context information subscription request includes at least one of a user identifier, a device identifier, a network identifier, and a service identifier, and a composite context information name.

13. The method of claim 12, further comprising:
determining whether composite context information indicated by a composite context information name has been defined; and
searching for, if the composite context information indicated by the composite context information name has been defined, a composite context information configuration list corresponding to composite context information indicated by the composite context information subscription request from a rule storage unit, and creating subscription information,
wherein the rule storage unit stores a composite context information configuration list including a plurality of pieces of unit context information configuring each piece of composite context information, and a composite context information rule representing a logical relationship between the plurality of pieces of unit context information.

14. The method of claim 13, wherein the subscription information includes the composite context information name, a composite context information identifier, the composite context information configuration list including a plurality of pieces of unit context information configuring the corresponding composite context information, an address of an application service server requesting subscription to the composite context information, and at least one of a user identifier, a device identifier, a network identifier, and a service identifier.

15. The method of claim 14, further comprising:
searching for, if the data of the collected unit context information is different from the previously collected data of the corresponding unit context information, subscription information including composite context information including the unit context information in a subscription information storage unit that stores at least one piece of subscription information created according to a composite context information subscription request;
searching for, if the subscription information including the composite context information including the unit context information is found, an address of an application service server requesting subscription to the composite context information; and
notifying the application service server requesting subscription to the composite context information that a composite situation corresponding to the composite context information has actually occurred, using the found address of the application service server.

16. The method of claim 15, wherein the searching for the subscription information including the composite context information including the unit context information comprises determining, if a plurality of pieces of subscribed composite context information including the unit context information are found in the subscription information storage unit, whether a composite situation corresponding to each of the plurality of pieces of composite context information has actually occurred.

17. The method of claim 15, wherein the unit context information includes service context information representing a state of a service provided on a network, and further comprising:
searching for, if the subscribed composite context information includes at least one piece of unit context information related to the service context information, all subscription information including the unit context information related to the service context information, and processing composite context information corresponding to all the found subscription information.

18. The method of claim 15, wherein the unit context information includes network context information, and further comprising:
searching for, if the subscribed composite context information includes at least one piece of unit context information related to the network context information, all subscription information including the unit context information related to the network context information, and processing composite context information corresponding to all the found subscription information.
